(19) United States
(12) Patent Application Publication
(10) Pub. No.: US 2013/0101966 A1
(43) Pub. Date: Apr. 25, 2013

(54) ORAL HEALTH INDEX

(71) Applicant: Prem Sreenivasan, Westfield, NJ (US)

(72) Inventor: Prem Sreenivasan, Westfield, NJ (US)

(73) Assignee: Colgate Palmolive Company, New York, NY (US)

(21) Appl. No.: 13/806,553

(22) PCT Filed: Jun. 30, 2010
(86) PCT No.: PCT/US10/40508

§ 371 Date: Dec. 21, 2012

(51) Int. Cl. A61C 19/04

(52) U.S. Cl. CPC A61C 19/04
USPC 433/215

(57) ABSTRACT

Methods of measuring a subject's Ayurvedic oral health are disclosed. The methods include examining the subject and assigning a health score for each of one or more Ayurvedic oral health parameters. The scores can be used to compare the Ayurvedic oral health of different populations, to assess changes in a subject's Ayurvedic oral health, and to assess the efficacy of Ayurvedic treatments.

### BACKGROUND OF THE INVENTION

Ayurvedic medicine is a holistic medicine developed gradually over thousands of years. Ayurveda (the “science/wisdom of life”) emphasizes the importance of balance, harmony, and moderation, valuing a balanced and healthy relationship between a person and his or her environment.

Just as Ayurvedic medicine is holistic, so too is the examination of subject undergoing Ayurvedic treatment. Ayurvedic medicine recognizes the individuality of each subject. Traditionally, an Ayurvedic examination is done using the five senses of the practitioner, studying not merely the current symptoms of the disease, but understanding the individual nature of the subject. Although several core Ayurvedic practices were recorded in classical texts thousands of years ago, Ayurvedic medicine has continued to blossom and diversify in the modern era, which has seen the formation of institutes recording, developing, testing and sharing Ayurvedic practices.

Many products are marketed to people wishing to improve their Ayurvedic health. For example, dietary changes and the uses of specific oils and herbs have long been prescribed as a part of Ayurvedic therapy. Unfortunately, as no accepted gauge of Ayurvedic efficacy exists, it can be difficult or impossible for a consumer to know that an available product will be safe or effective.

### SUMMARY OF THE INVENTION

The present invention is based, in part, on the discovery that an Ayurvedic clinical index can be used to assess a subject's Ayurvedic oral health. The availability of an Ayurvedic clinical index not only permits an assessment of that individual's health, but permits comparative measurements over time, or between individuals.

Thus, in one aspect, the invention provides a method of measuring a subject's Ayurvedic oral health. The method includes examining the subject and assigning a health score to the subject for each of one or more Ayurvedic oral health parameters. The subject's Ayurvedic oral health is measured by comparing the health score obtained from the subject to a standardized health score. In one embodiment, the Ayurvedic oral health parameters are selected from the group consisting of gum margin redness, gum bleeding, and tooth debris.

In one embodiment, a health score is assigned for at least two of the Ayurvedic oral health parameters. The method can include deriving a single overall Ayurvedic oral health score from the health scores for each of the individual Ayurvedic oral health parameters. For example, the overall Ayurvedic oral health score can be the average of the health scores for each of the individual Ayurvedic oral health parameters.

In another embodiment, a method is provided for measuring the oral health of an Ayurvedic clinical index can be used to assess a subject's Ayurvedic oral health. The availability of an Ayurvedic clinical indexes art individual which not only permits an assessment of that individual's health, but permits comparative measurements over time, or between individuals.

Another embodiment of the present invention provides a method for measuring the oral health of an individual which can be used for detecting a change in a subject's Ayurvedic oral health.

Still another embodiment of the present invention is to provide an oral health evaluation method for a product or process of interest.

Yet another object of the present invention is to provide an oral health treatment method.

The invention also provides a method of comparing subjects' Ayurvedic oral health by performing any of the methods described above on a plurality of subjects, permitting comparisons among or between them.

The invention provides also methods of detecting a change in a subject's Ayurvedic oral health by repeatedly measuring the subject's oral health as described above and detecting a change (if any) in a health score over time. The health score can be an individual health score for any given Ayurvedic oral health parameter, or an overall score.

The invention also provides an oral health evaluation method for a product or process of interest. The method involves performing any of the methods described above on one or more subjects previously treated with a product or process to be evaluated. For example, the subject's Ayurvedic oral health parameter(s) can be scored before and after treatment with the product or process to be evaluated. In this manner, any health changes dependent on the product or process can be detected by comparison.

In another aspect, the invention provides an oral health treatment method. The method includes administering a product or process to a subject and subsequently measuring the subject's Ayurvedic oral health as described above.

### DETAILED DESCRIPTION

The following definitions and non-limiting guidelines must be considered in reviewing the description of this invention set forth herein. The headings (such as “Background” and “Summary”) used herein are intended only for general organization of topics within the disclosure of the invention, and are not intended to limit the disclosure of the invention or any aspect thereof. In particular, subject matter disclosed in the “Background” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. Any discussion of the content of references cited in the Introduction is intended merely to provide a general summary of assertions made by the authors of the references, and does not constitute an admission as to the accuracy of the content of such references.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations the stated of features. Specific Examples are provided for illustrative purposes of how to practice the methods of this invention and, unless explicitly stated otherwise, are not intended to be a representation that given embodiments of this invention have, or have not, been made or tested.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention. In addition, the compositions and the methods may comprise, consist essentially of, or consist of the elements described therein.

As used herein, the word “include,” and its variants, is intended to be non-limiting, such that recitation of items in a list is not to the exclusion of other like items that may also be useful in the materials, compositions, devices, and methods of this invention.

As used throughout, ranges are used as a shorthand for describing each and every value that is within the range. Any value within the range can be selected as the terminus of the range. In addition, all references cited herein are hereby incorporated by reference in their entireties. In the event of a conflict in a definition in the present disclosure and that of a cited reference, the present disclosure controls.

The present invention provides a method of measuring a subject's Ayurvedic oral health. The method includes examining the subject and assigning a health score to the subject for each of one or more Ayurvedic oral health parameters. The subject's Ayurvedic oral health is measured by comparing the health score obtained from the subject to a standardized health score. In one embodiment, the Ayurvedic oral health parameters are selected from the group consisting of at least one gum margin redness, gum bleeding, and tooth debris.

In one embodiment, a health score is assigned for at least two of the Ayurvedic oral health parameters. The method can include deriving a single overall Ayurvedic oral health score from the health scores for each of the individual Ayurvedic oral health parameters. For example, the overall Ayurvedic oral health score can be the average of the health scores for each of the individual Ayurvedic oral health parameters.

The invention also provides a method of comparing subjects' Ayurvedic oral health by performing any of the methods described above on a plurality of subjects, permitting comparisons among or between them.

The invention provides also methods of detecting a change in a subject's Ayurvedic oral health by repeatedly measuring the subject's oral health as described above and detecting a change (if any) in a health score over time. The health score can be an individual health score for any given Ayurvedic oral health parameter, or an overall score.

The invention also provides an oral health evaluation method for a product or process of interest. The method involves performing any of the methods described above on one or more subjects previously treated with a product or process to be evaluated. For example, the subject's Ayurvedic oral health parameter(s) can be scored before and after treatment with the product or process to be evaluated. In this manner, any health changes dependent on the product or process can be detected by comparison.

In another aspect, the invention provides an oral health treatment method. The method includes administering a product or process to a subject and subsequently measuring the subject's Ayurvedic oral health as described above.

The present invention permits the use of Ayurveda-based clinical endpoints to assess oral health in a quantitative matter that permits comparisons between individuals or groups. Quantitation also permits the assessment of changes in an individual's Ayurvedic oral health over time. Methods in accordance with the invention can therefore be used to measure the efficacy of an oral care formulation in improving one or more Ayurvedic health parameters; to assess the relationship of an Ayurvedic oral health treatment with systemic health; and to improve the specificity, objectivity and verifiability of statements regarding the effects of a product or process on Ayurvedic oral health. Thus, not only can an individual's Ayurvedic oral health be assessed, but products can be measured and, over time, improved as ingredients and formulations that maximize performance on one or more Ayurvedic oral health parameters are identified. By providing a method for measuring a subject's Ayurvedic oral health, the invention facilitates the systematic analysis, comparison, development and improvement of methods, systems and products for improving Ayurvedic health.

The measurement of a subject's Ayurvedic oral health begins with examination of the subject. Examination is preferably done by an experienced Ayurvedic practitioner. The examination must include an assessment of one or (preferably) more Ayurvedic oral health parameters for the subject. Suitable oral health parameters can include for example, dental debris, gum redness, gum bleeding, coating on the tongue, gum inflammation, breath odor, and oral dryness, separately or in combination. Thus, for example examination could include dental debris and/or gum redness, optionally in combination with any one, two, three or four of the above oral health parameters—or could include any or all of the above.

For each Ayurvedic oral health parameter to be included in the measurement process, a health score is assigned. The health score can be based on a fixed scale, such as a seven point scale, a ten point scale, or a one hundred point scale. Numerical scales are preferred, although other scales, such as those based on letters of the alphabet, could also be used. One end of the scale, such as the end with higher numbers, is used to indicate better Ayurvedic health according to the oral health parameter in question (e.g. less debris, redness, bleeding, inflammation, odor, or dryness, or less coating on the tongue). Each health score determined for the subject is preferably recorded. Recording of the health score can be done by hand, although recordation in a computer system is sometimes preferred, particularly if the Ayurvedic oral health of two populations is to be compared (as may be done when comparing the effects of oral health regimens in different groups of subjects).

A subject's Ayurvedic oral health can be measured by comparing the observed health score to a standardized score. For example, on a ten point scale, a score of 4-6 may indicate average Ayurvedic health, whereas a score of 0-2 may indicate poor Ayurvedic health.

Where health scores are measured for each of at least two Ayurvedic oral health parameters of a subject, they can optionally be used to derive a combination Ayurvedic oral health score, such as an overall Ayurvedic oral health score. For example, the combination Ayurvedic oral health score could be the average of the health scores for the individual Ayurvedic oral health parameters. Alternatively, the combination Ayurvedic oral health score could represent a median score, a geometric mean score, a weighted mean score, or a summation or product of the individual health scores, to name but a few examples.

A combination Ayurvedic oral health score can be determined by the person examining the subject, or can be calculated by others. For example, the individual health scores can be recorded in tangible form and/or provided to a computer. In addition to the Ayurvedic scores, a record can also include data about the subject. These data may include, for example, subject information such as one or more of: age; gender; weight; dietary habits; hygienic habits; behavioral traits; medical history; family history and status; psychological traits and/or stressors; spirituality; etc. These data may include information identifying the subject. Alternatively, if the information is included in a population study or clinical trial, the record optionally excludes any information sufficient to identify the subject. If a computer is used, all or a portion of the record can be stored and/or electronically transmitted in a computer-readable form. A computer can, for example, determine overall Ayurvedic oral health scores based on a plurality of individual Ayurvedic oral health parameters, and report the overall score to the Ayurvedic practitioner or to another person authorized to access the information.

Ayurvedic oral health scores can be used to compare the Ayurvedic health of different populations. The different populations may or may not be separated geographically. For example, the oral health scores of populations living in different neighborhoods of a city can be compared. Differences in the local environment (e.g. in the water supply, or in the air) may trigger a statistically significant difference in the Ayurvedic oral health observed in the different neighborhoods. Alternatively, the populations measured may not be separated geographically, but by any other measure of interest, such as socioeconomic status, age, gender, education, profession, culture, family status, medical history, etc.

Ayurvedic oral health scores can also be used to assess the effects of a particular product or regimen on oral health. For example, the oral health of an individual can be measured before and after a particular event. The event may relate to the individual's general well-being, such as a change in job status or location, an exercise or dietary regimen, or a lifestyle change. The event may also be more directly related to oral health, as in a change in oral hygiene practice. Such a change could involve using an oral hygiene tool, such as a brush, a floss, or a scraper, to assess the efficacy of the tool in improving Ayurvedic oral health. The event could also involve using an oral care composition, such as a dentifrice, rinse, paste, gum, gel, powder, cream, mousse, etc., to determine the effect of the oral care composition on Ayurvedic oral health by measuring a change in one or more of the subject's Ayurvedic oral health scores. Such an oral care composition preferably contains one or more plant components, such as an oil or extract from an appropriate herb or other plant that may benefit Ayurvedic oral or overall health. Of course, an oral care composition can contain also contain various active and/or carrier ingredients, such as humectants, inorganic dispersants, bicarbonate salts, pH modifying agents, surfactants, foam modulators, thickening agents, viscosity modifiers, sweeteners, flavorants, colorants, anticaries agents, anticalculus agents, stannous ion sources, zinc ion sources, breath fresheners, antiplaque agents, enzymes, vitamins, anti-adhesion agents and combinations thereof.

In some embodiments, the present invention provides methods for evaluating the oral health of a mammalian subject, comprising: (a) examining from about 5-15 sites in the oral cavity of said subject at a first time point; (b) assigning a first health score to each of the sites examined at said first time point; (c) recording said first health score obtained from each of the sites examined on a scorecard; (d) re-examining said sites examined at said first time point at a second time point; (e) assigning a second health score to each of the sites re-examined at said second time point; (f) recording said second health score obtained from each of the sites re-examined on a scorecard; (g) comparing said first health score with said second health score. In some embodiments, 8-12 sites are examined at said first time point. In some embodiments, 10 sites are examined at said first time point. In some embodiments, a second health score that is greater than said first health score is indicative of an improvement in the oral health of a mammalian subject.

In some embodiments, the present invention provides kits for use in evaluating the oral health of a mammalian subject in need thereof, comprising: a dentifrice; a scorecard for recording the health score obtained using any of the foregoing methods; and instructions for using said kit.

Developing a statistically significant assessment of the efficacy of an oral hygiene tool, an oral care composition, or other product or treatment generally involves administering the product or process to a number of individuals and measuring their Ayurvedic oral health. In some cases, conclusions can be drawn from Ayurvedic oral health scores taken before and after the product or process is administered. Any statistically significant change in the scores of the population before and after administration may be an indication of the efficacy (or harm) of the product or process. This may involve, for example, a significant improvement in one or more average Ayurvedic oral health scores, or a change in the distribution of the scores, such as a statistically significant decrease in subjects with one or more scores evidencing poor Ayurvedic health, or a statistically significant increase in subjects with one or more scores evidencing above-average or excellent Ayurvedic health. Control populations, not receiving the product or process, can also be included in the assessment.

In this way, Ayurvedic oral health scores can be used to gauge the efficacy of a product or process in improving the Ayurvedic oral health of a population. The scores can also be used on an individual basis to confirm whether a particular product or process improves the Ayurvedic health of a given subject.

### Specific Embodiments of the Invention

The invention is further described in the following examples. The examples are merely illustrative and do not in any way limit the scope of the invention as described and claimed.

### Example 1

### Colgate Ayurveda Sampoorna Toothpaste Study

This study compared the efficacy of Colgate Ayurveda Sampoorna toothpaste formulated with Ayurveda-recommended ingredients to a control formulation without these ingredients. The Colgate Ayurveda Sampoorna toothpaste and the control toothpaste were coded and randomly assigned to the subjects. A board-certified Ayurveda physician examined each subject at baseline and after 6 and 12 weeks of the assigned toothpaste. Using a visual analog scale, the Ayurveda physician scores for dental debris and gum redness. In this scale, higher numbers indicated improvements in oral health. The results for dental debris and gum redness are shown in Tables 1 and 2, respectively. As shown, the Ayurvedic oral health scores demonstrated statistically significant improvements in Ayurvedic oral health among subjects assigned the Colgate Ayurveda Sampoorna toothpaste versus the control toothpaste. These effects were observed at both the 6 and 12 week assessments (p<0.0005).

TABLE 1
Ayurvedic Dental Debris Scores (average +/− standard deviation)

| | Number | | | |
|---|---|---|---|---|
| | of | | | |
| Product | subjects | Baseline | 6 weeks | 12 weeks |
| Control | 55 | 3.39 +/− 0.88 | 3.54 +/− 0.86 | 3.63 +/− 0.86 |
| Ayurveda | 57 | 3.45 +/− 0.86 | 3.95 +/− 0.75 | 4.18 +/− 0.79 |
| Sampoorna | | | | |
| p value | | 0.70 | <0.0005 | <0.0005 |
| | | (two sample | (analysis of | (analysis of |
| | | t-test, not | covariance, | covariance, |
| | | significant) | significant) | significant) |
| % | | | 11% | 15% |
| improvement | | | | |
| by Ayurveda | | | | |
| vs. control | | | | |

TABLE 2
Ayurvedic Gum Redness Scores (average +/− standard deviation)

| | Number | | | |
|---|---|---|---|---|
| | of | | | |
| Product | subject | Baseline | 6 weeks | 12 weeks |
| Control | 55 | 3.30 +/− 0.67 | 3.44 +/− 0.66 | 3.55 +/− 0.66 |
| Ayurveda | 57 | 3.41 +/− 0.84 | 3.87 +/− 0.76 | 4.11 +/− 0.79 |
| Sampoorna | | | | |
| p value | | 0.446 | 0.0005 | 0.0005 |
| | | (two sample | (analysis of | (analysis of |
| | | t-test, not | covariance, | covariance, |
| | | significant) | significant) | significant) |
| % | | | 12% | 15% |
| improvement | | | | |
| by Ayurveda | | | | |
| vs. control | | | | |

### Example 2

### Four Parameter Ayurvedic Examination

A subject receives an Ayurvedic oral health examination scoring each of the following parameters:

Bleeding from gums

Plaque/debris on teeth

Redness on gum margins

Improvement in oral hygiene levels

An exemplary examination form is shown in Table 3, below. The exemplary form uses a ten point integer scale, with higher numbers indicating better Ayurvedic oral health. Other scales, including continuous scales and visual analog scales are also suitable. For this ten point integer scale, the subject is examined by an Ayurvedic practitioner trained in the use of the scale. The Ayurvedic practitioner will previously have examined a range of subjects with varying gum bleeding, plaque debris, gum redness, and oral hygiene. This prior experience facilitates the proper calibration of the Ayurvedic practitioner's scoring methodology.

The subject's teeth and oral cavity are examined and scored as follows:
Overall scores between 1 and 2.5: Majority of sites (>75%) of demonstrate signs or parameter examined.
Scores between 2.5 and 5: Between 50 and 75% of the sites demonstrate signs with reminder of sites generally free of signs.
Scores between 5 and 7.5: Symptoms or signs are observed at between 25 and 50% of the sites with the remainder of the sites are generally free of signs.
Scores between 7.5 and 10: Fewer than 25% of sites indicate signs or symptoms.

TABLE 3
Exemplary Ten Point/Four Parameter
Ayurvedic Examination Form

| | Parameter | Score |
|---|---|---|
| 1 | Bleeding from gums | 1 2 3 4 5 6 7 8 9 10 |
| 2 | Plaque/debris on | 1 2 3 4 5 6 7 8 9 10 |
| | teeth | |
| 3 | Redness on gum | 1 2 3 4 5 6 7 8 9 10 |
| | margins | |
| 4 | Improvement in | 1 2 3 4 5 6 7 8 9 10 |
| | Oral Hygiene | |

1. A method of measuring a subject's Ayurvedic oral health, the method comprising the steps of:
examining the subject for each of one or more Ayurvedic oral health parameters;
assigning a health score to the subject; and
measuring the subject's Ayurvedic oral health by comparing the health score obtained from the subject to a standardized health score;
wherein the health score is assigned for each of at least two of the Ayurvedic oral health parameters, and
wherein the method further comprises deriving a single overall Ayurvedic oral health score from the health scores for each of the individual Ayurvedic oral health parameters.

2. The method of claim 1, wherein the Ayurvedic oral health parameters are selected from the group consisting of gum margin redness, gum bleeding, and tooth debris.

3. (canceled)

4. (canceled)

5. The method of claim 1, wherein the overall Ayurvedic oral health score is the average of the health scores for each of the individual Ayurvedic oral health parameters.

6. A method of comparing subjects' Ayurvedic oral health, the method comprising performing a method according to claim 1 on a plurality of subjects.

7. A method of detecting a change in a subject's Ayurvedic oral health, the method comprising repeating a method according to claim 1 and detecting a change in a health score over time.

8. A method of detecting a change in a subject's Ayurvedic oral health, the method comprising repeating a method according to claim 1 and detecting a change in the overall Ayurvedic oral health score over time.

9. An Ayurvedic oral health evaluation method for a product or process of interest, the method comprising performing a method according to claim 1 on a subject previously treated with a product or process to be evaluated.

10. The method of claim 7, wherein the subject's Ayurvedic oral health parameters are scored before and after treatment with the product or process to be evaluated.

11. An oral health treatment method comprising the steps of administering a product or process to a subject and performing the method of claim 1.

12. A method for evaluating the oral health of a mammalian subject, comprising:
(a) examining from about 5-15 sites in the oral cavity of said subject at a first time point;
(b) assigning a first health score to each of the sites examined at said first time point;
(c) recording said first health score obtained from each of the sites examined on a scorecard;
(d) re-examining said sites examined at said first time point at a second time point;
(e) assigning a second health score to each of the sites re-examined at said second time point;
(f) recording said second health score obtained from each of the sites re-examined on a scorecard;
(g) comparing said first health score with said second health score.

13. The method of claim 10, wherein 8-12 sites are examined at said first time point.

14. The method of claim 10, wherein 10 sites are examined at said first time point.

15. The method of claim 10, wherein a second health score that is greater than said first health score is indicative of an improvement in the oral health of a mammalian subject.

16. A kit for use in evaluating the oral health of a mammalian subject in need thereof, comprising:
a dentifrice;
a scorecard for recording the health score obtained using any of the foregoing methods; and
instructions for using said kit.
